(19) United States
(12) Patent Application Publication
(10) Pub. No.: US 2022/0006941 A1
(43) Pub. Date: Jan. 6, 2022

(54) SOLID-STATE IMAGING DEVICE

(71) Applicant: Panasonic Intellectual Property Management Co., Ltd., Osaka (JP)

(72) Inventors: Motonori ISHII, Osaka (JP); Mitsuyoshi MORI, Kyoto (JP)

(21) Appl. No.: 17/482,253

(22) Filed: Sep. 22, 2021

Related U.S. Application Data
(63) Continuation of application No. PCT/JP2020/001700, filed on Jan. 20, 2020.

(30) Foreign Application Priority Data
Mar. 27, 2019 (JP) 2019-061424

(51) Int. Cl. H04N 5/235; H04N 5/225; G01S 17/894; G01S 7/486

(52) U.S. Cl. CPC H04N 5/2354; G01S 7/486; G01S 17/894; H04N 5/2256

(57) ABSTRACT

An AND gate 201 outputs an output signal A so that first pixels be exposed simultaneously in a light emission period included in a scan period, and an AND gate 205 outputs an output signal E so that pixel signals be read from the first pixels in a readout period after the light emission period. Also, an AND gate 206 outputs an output signal F so that pixel signals be read from second pixels in a period including the light emission period in the scan period.

### CROSS-REFERENCE TO RELATED APPLICATIONS

This is a continuation of International Application No. PCT/JP2020/001700 filed on Jan. 20, 2020, which claims priority to Japanese Patent Application No. 2019-061424 filed on Mar. 27, 2019. The entire disclosures of these applications are incorporated by reference herein.

### BACKGROUND

The present disclosure relates to a solid-state imaging device usable for distance measurement and camera image generation.

In solid-state imaging devices, efforts have conventionally been focused on taking images with high sensitivity and high definition. Recently, there have appeared solid-state imaging devices that have, in addition to the above capability, a function capable of acquiring distance information from objects. With distance information added to an image, it becomes possible to sense three-dimensional information of a subject to be imaged by a solid-state imaging device. For example, by taking an image of a person, the gesture of the person can be detected three-dimensionally. The device can therefore be used as an input device for various types of equipment. As another example, when mounted in a car, the device can recognize the distance from an object or a person present around the car, and therefore can be applied to collision prevention and automatic driving.

Among a number of methods used for distance measurement from a solid-state imaging device to an object, there is a time-of-flight (ToF) method in which light is emitted from near a solid-state imaging device toward an object and the time taken from the emission until the light returns to the solid-state imaging device after reflected from the object is measured. Japanese Unexamined Patent Publication No. 2004-294420 discloses a technology of applying the ToF method to a solid-state imaging device to obtain three-dimensional information.

In the cited patent document, the difference between reflected projection light (light pulse signal) from an object and background light obtained when the projection light is cut off is calculated, to obtain three-dimensional information using a phase difference of the above difference with a plurality of transfer gates.

In the above patent document, however, it is necessary to secure at least a certain level of intensity for the projection light as opposed to the intensity of the background light. In particular, for an object in the open with intense background light or an object in the distance, it is necessary to increase the intensity of the projection light.

The intensity of the projection light can be increased by decreasing the diffusion angle of the projection light (e.g., emitting linear projection light extending in the horizontal direction).

In this method, however, while signals for distance measurement are generated from pixels corresponding to the emission position of the projection light, i.e., pixels in given rows, in the pixel area, such signals are not generated from the other pixels. Therefore, being unable to use all pixels for distance measurement at the same timing, the solid-state imaging device is low in use efficiency.

It may be considered to use the pixels that do not correspond to the emission position of the projection light for taking camera images. However, during the distance measurement, the exposure time of pixels is very short, failing to secure an exposure time required for generation of sharp camera images.

In view of the problem described above, an objective of the present disclosure is providing a solid-state imaging device usable for distance measurement and camera image generation, capable of securing an exposure time required for generation of sharp camera images while making efficient use of pixels.

### SUMMARY

A solid-state imaging device according to one aspect of the present disclosure includes: a plurality of pixels arranged in a matrix; a ranging address circuit that selects pixels included in given number of rows, among the plurality of pixels, as first pixels used for distance measurement in a scan period during which exposure of the plurality of pixels and readout of pixel signals from the plurality of pixels are performed; a camera address circuit that selects pixels other than the first pixels, among the plurality of pixels, as second pixels used for camera image generation in the scan period; a first drive circuit that drives the first pixels; and a second drive circuit that drive the second pixels. The first drive circuit performs simultaneous exposure of the first pixels in a light emission period included in the scan period, and also performs readout of pixel signals from the first pixels in a readout period after the light emission period. The second drive circuit performs readout of pixel signals from the second pixels in a period including the light emission period in the scan period.

According to the above configuration, in a solid-state imaging device usable for distance measurement and camera image generation, it is possible to secure an exposure time required for generation of sharp camera images while making efficient use of pixels.

### BRIEF DESCRIPTION OF THE DRAWINGS

FIG. 1 is a schematic view showing a configuration example of a distance measuring device according to the first embodiment.

FIG. 2 is a circuit diagram showing a configuration example of a solid-state imaging device according to the first embodiment.

FIG. 3 is a circuit diagram showing a configuration example of a pixel according to the first embodiment.

FIG. 4 is a view showing an operation sequence of the solid-state imaging device according to the first embodiment.

FIG. 5 is a view showing an operation sequence of a solid-state imaging device according to the second embodiment.

FIG. 6 is a circuit diagram showing a configuration example of a solid-state imaging device according to the third embodiment.

FIG. 7 is a view showing an operation sequence of the solid-state imaging device according to the third embodiment.

FIG. 8 is a circuit diagram showing a configuration example of a ranging address circuit.

FIG. 9 is a view showing an operation sequence of the ranging address circuit.

### DETAILED DESCRIPTION

Embodiments of the present disclosure will be described hereinafter in detail based on the accompanying drawings. It is be noted that the following description of preferred embodiments is essentially mere illustration and by no means intended to limit the present disclosure, its applications, or its uses. For example, while specific block configurations and circuit configurations will be disclosed and the description will be made referring to these configurations, such disclosed configurations are merely illustrative and not restrictive.

### First Embodiment

Configuration of Distance Measuring Device

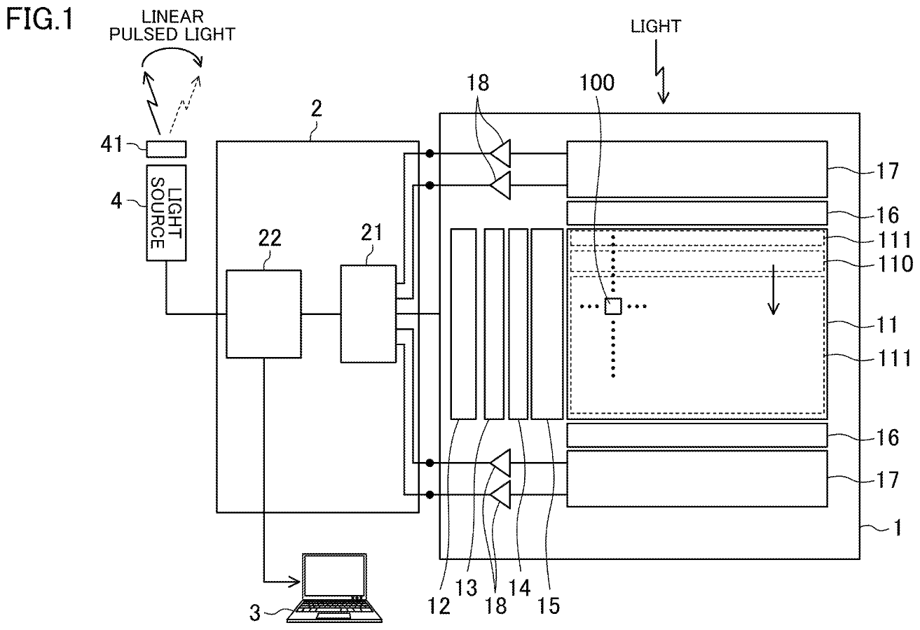

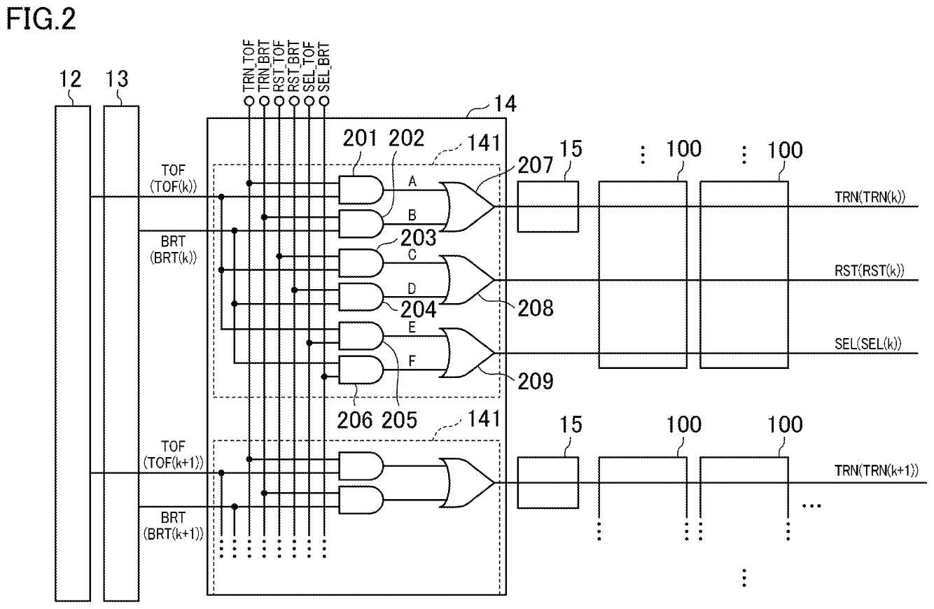

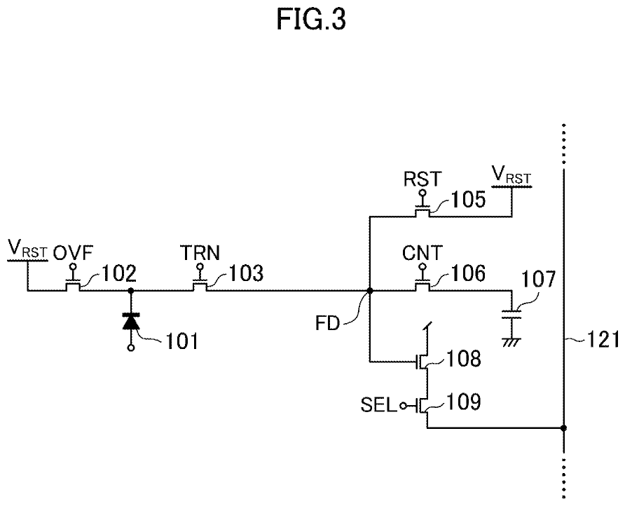

FIG. 1 is a schematic view showing a configuration example of a distance measuring device according to the first embodiment, FIG. 2 is a circuit diagram showing a configuration example of a solid-state imaging device according to the first embodiment, and FIG. 3 is a circuit diagram showing a configuration example of a pixel according to the first embodiment. Note that part of the solid-state imaging device is omitted in FIG. 2 for ease of explanation of the device.

As shown in FIG. 1, the distance measuring device of this embodiment includes a solid-state imaging device 1, a signal processor 2, a computing machine 3, and a light source 4.

The solid-state imaging device 1 includes a pixel array 11, a ranging address circuit 12, a camera address circuit 13, a multiplexer 14, a global shutter circuit 15, column circuits 16, horizontal shift registers 17, and output amplifiers 18.

The pixel array 11 includes pixels 100 arranged in a matrix. Each pixel 100 performs exposure according to an input exposure signal TRN. The pixel 100 also outputs an pixel signal indicating the exposure result to a vertical signal line 121 according to an input selection signal SEL. In the following description, the pixel array 11 is assumed to include N rows of pixels 100 (N is an integer).

Also, the pixel array 11 includes a first pixel region 110 and a second pixel region 111. The first pixel region 110 includes first pixels used for distance measurement, and the second pixel region 111 includes second pixels used for camera images. The first pixel region 110 corresponds to the emission position of projection light from the light source 4 and includes a plurality of rows of pixels 100.

The ranging address circuit 12, which includes circuits generating pulse signals, for example, selects a plurality of rows of pixels 100 from the pixel array 11 as the first pixels. Specifically, the ranging address circuit 12 generates first drive signals TOF indicating the drive timing of the selected first pixels and outputs the signals to the multiplexer 14.

The camera address circuit 13, which includes circuits generating pulse signals, for example, selects, as the second pixels, pixels 100 other than those selected as the first pixels from the pixel array 11. Specifically, the camera address circuit 13 selects pixels 100 other than the first pixels selected by the ranging address circuit 12 as the second pixels, generates second drive signals BRT indicating the drive timing of the second pixels, and outputs the signals to the multiplexer 14.

The multiplexer 14 includes a plurality of drive signal generation units 141, each provided for each row of the pixel array 11. Each of the drive signal generation units 141 receives a ranging exposure signal TRN_TOF, a camera exposure signal TRN_BRT, a ranging reset signal RST_TOF, a camera reset signal RST_BRT, a ranging selection signal SEL_TOF, and a camera selection signal SEL_BRT from outside. Also, the drive signal generation unit 141 outputs an exposure signal TRN to the global shutter circuit 15, and outputs a first reset signal RST and a selection signal SEL to the corresponding pixels 100. Although illustration is omitted in FIG. 2, the multiplexer 14 outputs a second reset signal OVF and a count signal CNT for each row of pixels 100. In the following description, the first drive signal, the second drive signal, the exposure signal, the first reset signal, the second reset signal, the selection signal, and the count signal corresponding to the k-th row of pixels 100 are respectively denoted as the first drive signal TOF(k), the second drive signal BRT(k), the exposure signal TRN(k), the first reset signal RST(k), the second reset signal OVF(k), the selection signal SEL(k), and the count signal CNT(k).

The global shutter circuit 15, provided for each row of pixels 100, for example, performs simultaneous exposure of pixels 100 arranged in the row direction when receiving the exposure signal TRN from the corresponding drive signal generation unit 141. For example, when receiving the exposure signal TRN(k), the global shutter circuit 15 outputs the exposure signal TRN(k) so that the pixels 100 arranged in the k-th row perform simultaneous exposure. Note that the global shutter circuit 15 may be omitted, and the multiplexer 14 may directly output the exposure signal TRN to the pixels 100.

The column circuits 16 receive pixel signals output from the pixels 100 through the vertical signal lines 121. The column circuits 16 perform processing such as correlated double sampling (CDS) of removing offset components different among the pixels 100, and output the results to the horizontal shift registers 17.

The horizontal shift registers 17 transfer the signals output from the column circuits 16 sequentially to the output amplifiers 18.

The output amplifiers 18 amplify the signals sequentially received from the horizontal shift registers 17 and output the results to the signal processer 2.

The signal processor 2 includes an analog front end 21 and a logic memory 22.

The analog front end 21 converts the signals output from the output amplifiers 18 of the solid-state imaging device 1 from analog to digital form. The analog front end 21 outputs the converted digital signals to the logic memory 22. The analog front end 21 may change the order of the signals output from the output amplifiers 18 as required.

The logic memory 22 generates distance signals and camera image signals based on the signals received from the analog front end 21. The generated distance signals and camera image signals are output to the computing machine 3.

The computing machine 3, which may be a computer, for example, makes up three-dimensional information on the surroundings of the solid-state imaging device 1 based on the distance signals input from the logic memory 22. The computing machine 3 also generates camera images based on the camera image signals input from the logic memory 22. Note that the signal processor 2 may make up three-dimensional information on the surroundings of the solid-state imaging device 1 and also generate camera images, based on the distance signals and the camera image signals.

The light source 4 projects light toward a place of which three-dimensional information is desired. The light source 4 includes a scan mechanism 41 to output linear pulsed light extending in the row direction. The output time and width of the pulsed light are controlled by the logic memory 22.

Configuration of Pixel

As shown in FIG. 3, the pixel 100 includes an avalanche photodiode 101, an overflow transistor 102, a transfer gate transistor 103, a reset transistor 105, a count transistor 106, a memory capacitor 107, an amplifying transistor 108, and a selection transistor 109.

The avalanche photodiode 101 performs photoelectric conversion of converting incident light into signal charges. The avalanche photodiode 101 amplifies the generated signal charges by several to several tens of times.

The overflow transistor 102 receives the second reset signal OVF at its gate and, when the second reset signal OVF is high, supplies a reset voltage VRST to the avalanche photodiode 101. That is, when the second reset signal OVF is high, the voltage in the avalanche photodiode 101 is reset to the reset voltage VRST.

The transfer gate transistor 103 receives the exposure signal TRN at its gate and, when the exposure signal TRN is high, transfers the signal charges in the avalanche photodiode 101 to floating diffusion FD. That is, when the exposure signal TRN is high, the pixel 100 performs exposure.

The reset transistor 105 receives the first reset signal RST at its gate and, when the first reset signal RST is high, supplies the reset voltage VRST to the floating diffusion FD. That is, when the first reset signal RST is high, the floating diffusion FD is reset to the reset voltage VRST.

The count transistor 106 receives the count signal CNT at its gate and, when the count signal CNT is high, transfers the signal charges stored in the floating diffusion FD to the memory capacitor 107. The memory capacitor 107 stores the signal charges transferred through the count transistor 106. That is, the signal charges based on the exposure result are stored in the memory capacitor 107.

The amplifying transistor 108 amplifies a voltage corresponding to the signal charges stored in the floating diffusion FD and outputs the result to the selection transistor 109.

The selection transistor 109 receives the selection signal SEL at its gate and, when the selection signal SEL is high, outputs a pixel signal corresponding to the voltage received from the amplifying transistor 108 to the vertical signal line 121. That is, when the selection signal SEL is high, the pixel signal is read from the pixel 100.

Configuration of Multiplexer

As shown in FIG. 2, the multiplexer 14 has the drive signal generation unit 141 provided for each row of pixels 100. The drive signal generation unit 141 includes AND gates 201 to 206 and OR gates 207 to 209.

The AND gate 201 calculates the logical AND of the first drive signal TOF and the ranging exposure signal TRN_TOF and outputs the result to the OR gate 207 as an output signal A. The AND gate 202 calculates the logical AND of the second drive signal BRT and the camera exposure signal TRN_BRT and outputs the result to the OR gate 207 as an output signal B. The OR gate 207 calculates the logical OR of the output signal A and the output signal B and outputs the result to the pixels 100 as the exposure signal TRN. That is, when both the first drive signal TOF and the ranging exposure signal TRN_TOF are high, or when both the second drive signal BRT and the camera exposure signal TRN_BRT are high, the exposure signal TRN goes high, whereby the pixels 100 perform exposure.

The AND gate 203 calculates the logical AND of the first drive signal TOF and the ranging reset signal RST_TOF and outputs the result to the OR gate 208 as an output signal C. The AND gate 204 calculates the logical AND of the second drive signal BRT and the camera reset signal RST_BRT and outputs the result to the OR gate 208 as an output signal D. The OR gate 208 calculates the logical OR of the output signal C and the output signal D and outputs the result to the pixels 100 as the first reset signal RST. That is, when both the first drive signal TOF and the ranging reset signal RST_TOF are high, or when both the second drive signal BRT and the camera reset signal RST_BRT are high, the first reset signal RST goes high, whereby the floating diffusion FD in each pixel 100 is reset to the reset voltage VRST.

The AND gate 205 calculates the logical AND of the first drive signal TOF and the ranging selection signal SEL_TOF and outputs the result to the OR gate 209 as an output signal E. The AND gate 206 calculates the logical AND of the second drive signal BRT and the camera selection signal SEL_BRT and outputs the result to the OR gate 209 as an output signal F. The OR gate 209 calculates the logical OR of the output signal E and the output signal F and outputs the result to the pixels 100 as the selection signal SEL. That is, when both the first drive signal TOF and the ranging selection signal SEL_TOF are high, or when both the second drive signal BRT and the camera selection signal SEL_BRT are high, the selection signal SEL goes high, whereby the pixels 100 perform readout of pixel signals.

Operation of Solid-State Imaging Device

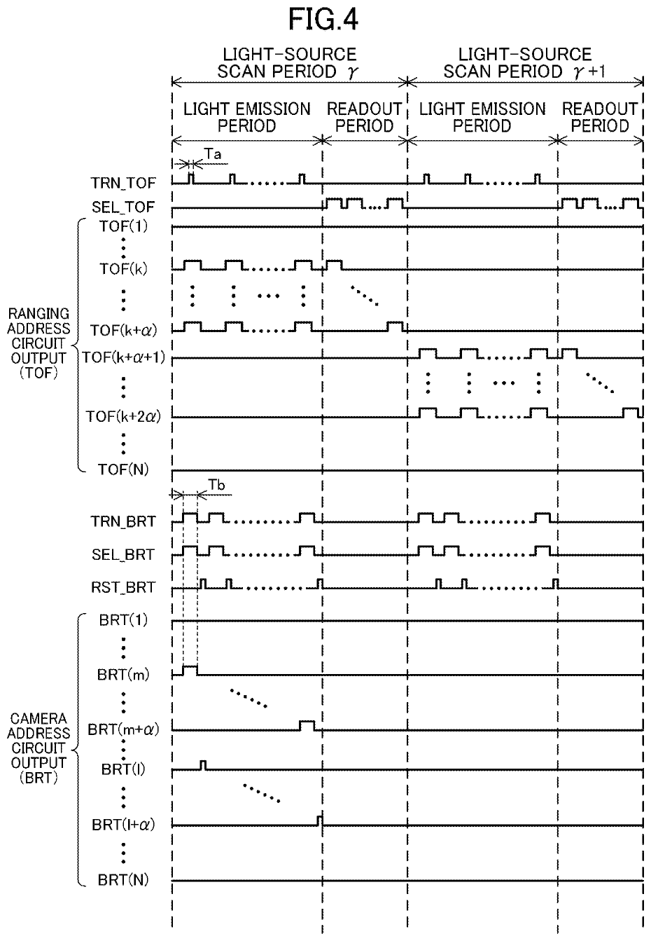

FIG. 4 shows an operation sequence of the solid-state imaging device. Specifically, FIG. 4 shows operations of the solid-state imaging device in light-source scan periods γ and γ+1.

The solid-state imaging device 1 performs operations in M light-source scan periods, including the periods γ and γ+1, to generate distance images and camera images for one frame. In each scan period, the ranging address circuit 12 selects α rows of pixels 100 corresponding to the emission position of the light source 4 as the first pixels, and the camera address circuit 13 selects pixels 100 other than the first pixels as the second pixels.

In FIG. 4, in the light-source scan period γ, pixels 100 in the k-th to (k+α)th rows of the pixel array 11 are selected as the first pixels, and pixels 100 in the m-th to (m+α)th and the l-th to (l+α)th rows are selected as the second pixels. In the light-source scan period γ+1, pixels 100 in the (k+α+1)th to (k+2α)th rows of the pixel array 11 are selected as the first pixels.

Each light-source scan period is divided into a light emission period and a readout period.

First, the operation of the first pixels will be described.

In the light emission period of the light-source scan period γ, the ranging address circuit 12 makes the first drive signals TOF(k) to TOF(k+α) high. Subsequently, the ranging exposure signal TRN_TOF goes high. Therefore, the output signal A output from the AND gate 201 in each of the drive signal generation units 141 corresponding to the pixels 100 in the k-th to (k+α)th rows becomes high, and thus the exposure signals TRN(k) to TRN(k+α) become high. This turns on the transfer gate transistor 103 in each of the pixels 100 in the k-th to (k+α)th rows, starting transfer of the signal charges from the avalanche photodiode 101 to the floating diffusion FD. That is, simultaneous exposure of the first pixels is started.

The ranging exposure signal TRN_TOF then goes low, whereby the output signal A output from the AND gate 201 becomes low, and thus the exposure signals TRN(k) to TRN(k+α) become low. Therefore, in each of the pixels 100 in the k-th to (k+α)th rows, the transfer gate transistor 103 is turned off, stopping the transfer of the signal charges from the avalanche photodiode 101 to the floating diffusion FD. That is, the simultaneous exposure of the first pixels is terminated. The ranging address circuit 12 then makes the first drive signals TOF(k) to TOF(k+α) low, resuming the initial state.

The operation described above is performed a plurality of times for the first pixels in the light emission period. That is, in the solid-state imaging device 1 of this embodiment, simultaneous exposure of the first pixels is performed a plurality of times.

Thereafter, in the readout period of the light-source scan period γ, the ranging selection signal SEL_TOF goes high. Also, the ranging address circuit 12 makes the first drive signal TOF(k) high. Therefore, the output signal E output from the AND gate 205 in the drive signal generation unit 141 corresponding to the pixels 100 in the k-th row becomes high, and thus the selection signal SEL(k) becomes high. This turns on the selection transistor 109 in each of the pixels 100 in the k-th row, outputting a pixel signal from the pixel 100. That is, readout of pixel signals from the pixels 100 in the k-th row is started. The ranging selection signal SEL_TOF and the first drive signal TOF(k) then go low, stopping the output of pixel signals from the pixels 100 in the k-th row. That is, the readout of pixel signals from the pixels 100 in the k-th row is terminated.

The above operation is then performed sequentially for the pixels 100 in the (k+1)th to (k+α)th rows. That is, the readout of pixel signals from the first pixels is performed row by row.

Thereafter, in the light-source scan period γ+1, while changing the emission position of the light source 4 to correspond to the pixels 100 in the (k+α+1)th to (k+2α)th rows, the solid-state imaging device 1 performs the operation described above for the pixels 100 in the (k+α+1)th to (k+2α)th rows in a similar way. That is, the ranging address circuit 12 selects the first pixels shifting the rows of pixels 100 by α rows every light-source scan period. In the solid-state imaging device 1, therefore, the pixels 100 selected as the first pixels are changed every scan period.

Next, the operation of the second pixels will be described.

In the light emission period of the light-source scan period γ, the camera address circuit 13 makes the second drive signal BRT(m) high. Also, the camera exposure signal TRN_BRT and the camera selection signal SEL_BRT go high. Therefore, the output signal B output from the AND gate 202 in the drive signal generation unit 141 corresponding to the pixels 100 in the m-th row becomes high, and thus the exposure signal TRN(m) becomes high. Also, the output signal F output from the AND gate 206 in the drive signal generation unit 141 corresponding to the pixels 100 in the m-th row becomes high, and thus the selection signal SEL(m) becomes high. This turns on the transfer gate transistor 103 and the selection transistor 109 in each of the pixels 100 in the m-th row, starting exposure of the pixels 100 in the m-th row and also starting readout of pixel signals from the pixels 100 in the m-th row. The camera address circuit 13 then makes the second drive signal BRT(m) low, and also the camera exposure signal TRN_BRT and the camera selection signal SEL_BRT go low, terminating the exposure of the pixels 100 in the m-th row and also terminating the readout of pixel signals from the pixels 100 in the m-th row.

The camera exposure time Tb during which the camera exposure signal TRN_BRT is high is set longer than the ranging exposure time Ta during which the ranging exposure signal TRN_TOF is high. That is, in each light-source scan period, the pixels 100 selected as the second pixels are exposed longer than the pixels 100 selected as the first pixels.

The camera address circuit 13 then makes the second drive signal BRT(1) high. Also, the camera reset signal RST_BRT goes high. Therefore, the output signal D output from the AND gate 204 in the drive signal generation unit 141 corresponding to the pixels 100 in the l-th row becomes high, and thus the first reset signal RST(1) becomes high. This turns on the reset transistor 105, supplying the reset voltage VRST to the floating diffusion

FD. That is, the floating diffusion FD in each of the pixels 100 in the l-th row is reset to the reset voltage VRST.

The operation described above is performed for the pixels 100 in the (m+1)th to (m+α)th and (l+1)th to (l+α)th rows in a similar way.

Thereafter, although illustration is omitted, the camera address circuit 13 selects the second pixels shifting the rows of pixels 100 by α rows every light-source scan period. That is, in the solid-state imaging device 1, the pixels 100 selected as the second pixels are changed every scan period.

With the above configuration, the pixels 100 in the k-th to (k+α)th rows of the pixel array 11 are selected as the first pixels used for distance measurement by the ranging address circuit 12. Also, the pixels 100 in the m-th to (m+α)th rows of the pixel array 11, other than the first pixels, are selected as the second pixels used for camera image generation by the camera address circuit 13. The AND gate 201 of the multiplexer 14 outputs the output signal A so that the first pixels perform simultaneous exposure in the light emission period of the scan period, and the AND gate 205 of the multiplexer 14 outputs the output signal E so that pixel signals be read from the first pixels in the readout period following the light emission period. Also, the AND gate 206 of the multiplexer 14 outputs the output signal F so that pixel signals be read from the second pixels in a period including the light emission period of the scan period. That is, while the first pixels are used for distance measurement, the second pixels are used for camera image generation. It is therefore possible to use the pixels 100 without being wasted. Also, in the period including the light emission period of the scan period, pixel signals from the second pixels are read by way of the AND gate 206 different from the AND gates 201 and 205 for driving the first pixels. This makes it possible to expose the second pixels longer than the first pixels. Thus, in the solid-state imaging device 1 usable for distance measurement and camera image generation, it is possible to secure the exposure time required for generation of sharp camera images while making efficient use of the pixels 100.

Also, the ranging address circuit 12 outputs the first drive signal TOF indicating the drive timing of the first pixels for each row of the first pixels. The camera address circuit 13 outputs the second drive signal BRT indicating the drive timing of the second pixels for each row of the second pixels. The multiplexer 14 receives the ranging exposure signal TRN_TOF indicating the exposure timing of the first pixels, the ranging selection signal SEL_TOF indicating the output timing of pixel signals of the first pixels, the camera exposure signal TRN_BRT indicating the exposure timing of the second pixels, and the camera selection signal SEL_BRT indicating the output timing of pixel signals of the second pixels, and outputs the exposure signals TRN and the selection signals SEL to the pixels 100. The exposure signal TRN for the first pixels is generated by the logical AND of the first drive signal TOF and the ranging exposure signal TRN_TOF. The selection signal SEL for the first pixels is generated by the logical AND of the first drive signal TOF and the ranging selection signal SEL_TOF. The exposure signal TRN for the second pixels is generated by the logical AND of the second drive signal BRT and the camera exposure signal TRN_BRT. The selection signal SEL for the second pixels is generated by the logical AND of the second drive signal BRT and the camera selection signal SEL_BRT. In this way, by calculating the logical AND of a signal indicating the drive timing of the first or second pixels and a signal indicating the drive timing of each item of the drive, it becomes unnecessary to provide a circuit for generating a control signal for each row of pixels 100 and for each item of the drive, whereby the area of the solid-state imaging device 1 can be reduced.

Note that, while the exposure of the second pixels and the output of pixel signals from the second pixels are performed simultaneously in this embodiment, they may be performed at different timing.

### Second Embodiment

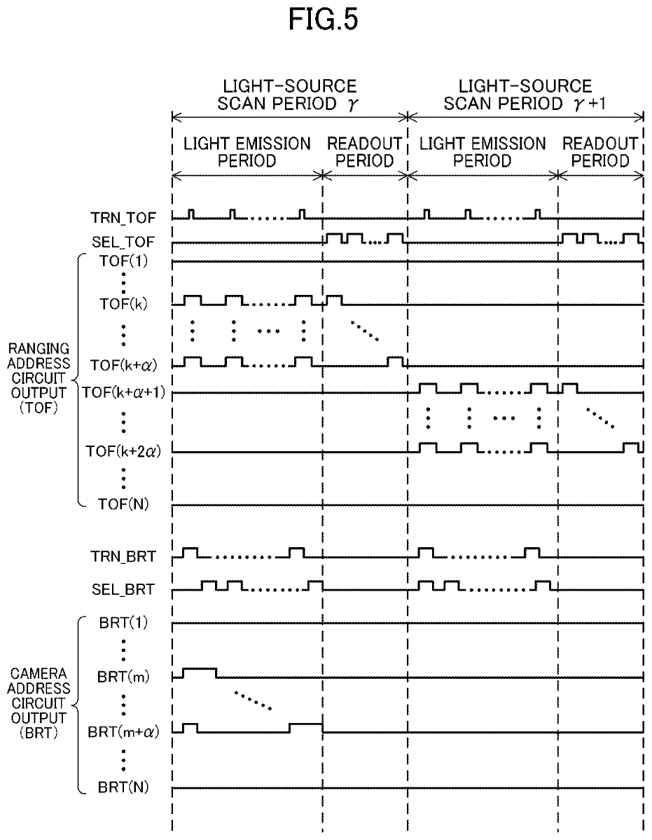

FIG. 5 shows an operation sequence of a solid-state imaging device according to the second embodiment. The configuration of the solid-state imaging device of the second embodiment is the same as that of the solid-state imaging device of the first embodiment. In FIG. 5, in the light emission period of the light-source scan period γ, simultaneous exposure of the second pixels is performed, and thereafter pixel signals are read from the second pixels.

Specifically, in the light emission period of the light-source scan period γ, the camera address circuit 13 makes the second drive signals BRT(m) to BRT(m+α) high. Also, the camera exposure signal TRN_BRT goes high. Therefore, the exposure signals TRN(m) to TRN(m+α) become high, turning on the transfer gate transistor 103 in each of the pixels 100 in the m-th to (m+α)th rows. That is, simultaneous exposure of the second pixels is started.

The camera exposure signal TRN_BRT then goes low, and thus the exposure signals TRN(m) to TRN(m+α) become low, turning off the transfer gate transistor 103 in each of the pixels 100 in the m-th to (m+α)th rows. That is, the simultaneous exposure of the second pixels is terminated.

Thereafter, the camera address circuit 13 makes the second drive signals BRT(m+1) to BRT(m+α) low. Also, the camera selection signal SEL BRT goes high. Therefore, the selection signal SEL(m) becomes high, turning on the selection transistor 109 in each of the pixels 100 in the m-th row. That is, readout of pixel signals from the pixels 100 in the m-th row is started.

The camera address circuit 13 then makes the second drive signal BRT(m) low. Therefore, the selection signal SEL(m) becomes low, turning off the selection transistor 109 in each of the pixels 100 in the m-th row. That is, the readout of pixel signals from the pixels 100 in the m-th row is terminated.

Thereafter, after the simultaneous exposure of the second pixels, the operation described above is preformed for the pixels in the (m+1)th to (m+α)th rows in a similar way. In this way, pixel signals required for generating sharp camera images can be obtained from the second pixels.

In this embodiment, after termination of the simultaneous exposure of the second pixels, the count signals CNT for the pixels 100 in the (m+1)th to (m+α)th rows may be made high, to turn on the count transistor 106 and thus transfer the signal charges from the floating diffusion FD to the memory capacitor 107 in each pixel.

### Third Embodiment

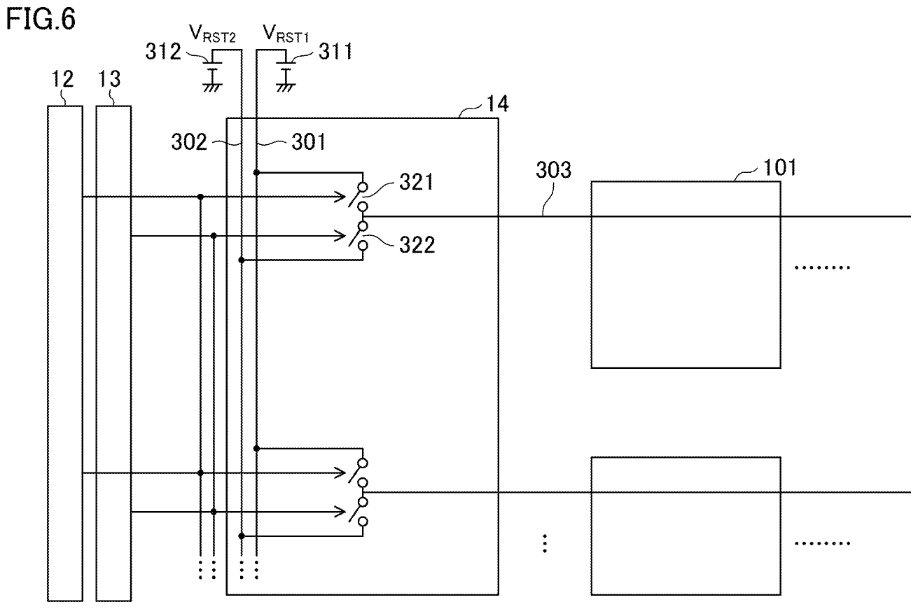

FIG. 6 is a circuit diagram showing a configuration example of a solid-state imaging device according to the third embodiment. Note that part of the solid-state imaging device is omitted in FIG. 6 for ease of explanation.

As shown in FIG. 6, the multiplexer 14 further includes a first power supply line 301, a second power supply line 302, a third power supply line 303, and switches 321 and 322. The third power supply line 303 and the switches 321 and 322 are provided for each row of pixels 100.

The multiplexer 14 is connected with a first power supply 311 through the first power supply line 301, and receives a first reset voltage VRST1 from the first power supply 311. Also, the multiplexer 14 is connected with a second power supply 312 through the second power supply line 302, and receives a second reset voltage VRST2 from the second power supply 312. The first reset voltage VRST1 is higher than the second reset voltage VRST2. For example, the first reset voltage VRST1 is 3 V, and the second reset voltage VRST2 is 1.5 V to 2 V.

The first power supply line 301 is connected with the third power supply line 303 through the switch 321, and the second power supply line 302 is connected with the third power supply line 303 through the switch 322. The switch 321 connects the first power supply line 301 and the third power supply line 303 when receiving a high-level first drive signal TOF from the ranging address circuit 12. The switch 322 connects the second power supply lien 302 and the third power supply line 303 when receiving a high-level second drive signal BRT from the camera address circuit 13. Although illustration is omitted, the third power supply line 303 is connected to the source of the overflow transistor 102 and the source of the reset transistor 105 of each of the pixels 100 arranged in the row direction. That is, the multiplexer 14 supplies the first reset voltage VRST1 or the second reset voltage VRST2 as the reset voltage VRST in FIG. 3.

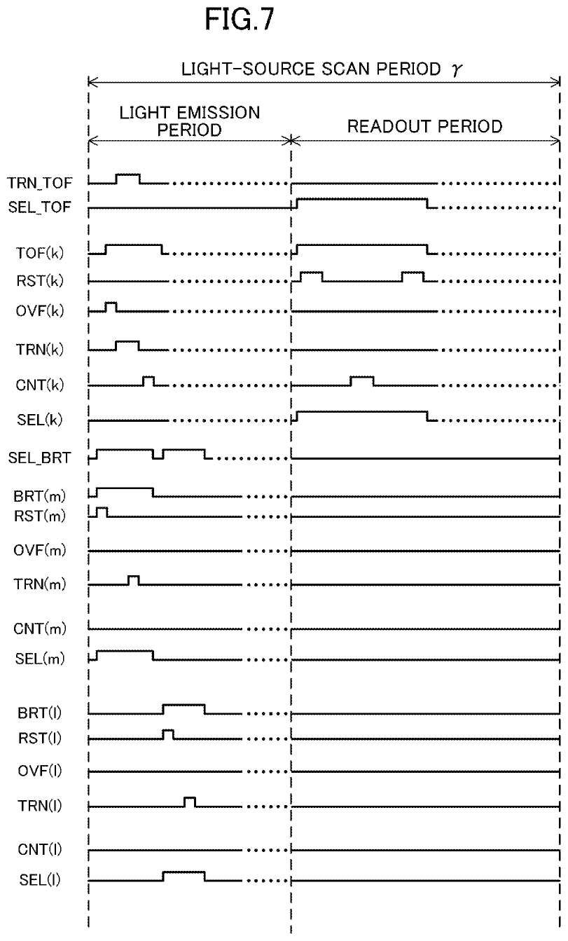

FIG. 7 shows an operation sequence of the solid-state imaging device of the third embodiment. Specifically, FIG. 7 shows operation sequences of the pixels 100 in the k-th, m-th, and l-th rows in the light-source scan period γ.

First, the operation of the first pixels will be described.

In the light emission period, the ranging address circuit 12 makes the first drive signals TOF(k) to TOF(k+α) high. Also, the second reset signals OVF(k) to OVF(k+α) go high. This turns on the overflow transistor 102 in each of the pixels in the k-th to (k+α)th rows. At this time, since the first power supply line 301 and the third power supply line 303 are connected through the switch 321, the first reset voltage VRST1 is supplied to the avalanche photodiode 101. That is, the avalanche photodiodes 101 in the first pixels are reset to the first reset voltage VRST1.

The second reset signals OVF(k) to OVF(k+α) then go low, and concurrently the exposure signals TRN(k) to TRN(k+α) go high, whereby simultaneous exposure of the first pixels is performed.

The exposure signals TRN(k) to TRN(k+α) then go low, and the count signals CNT(k) to CNT(k+α) go high. That is, signal charges based on the exposure result are stored in the memory capacitor 107 in each of the first pixels.

The count signals CNT(k) to CNT(k+α) then go low, and the ranging address circuit 12 makes the first drive signals TOF(k) to TOF(k+α) low.

The above operation is performed a plurality of times for the first pixels in the light emission period.

Thereafter, in the readout period of the light-source scan period γ, the ranging selection signal SEL_TOF and the first reset signal RST(k) go high. Also, the ranging address circuit 12 makes the first drive signal TOF(k) high. This turns on the reset transistor 105 and the selection transistor 109. At this time, since the first power supply line 301 and the third power supply line 303 are connected through the switch 321, the first reset voltage VRST1 is supplied to the floating diffusion FD. That is, the floating diffusion FD in each of the pixels 100 in the k-th row is reset to the first reset voltage VRST1.

The first reset signal RST(k) then goes low, and the count signal CNT(k) goes high. This turns on the count transistor 106, whereby the signal charges accumulated in the memory capacitor 107 are transferred to the floating diffusion FD and a pixel signal corresponding to the voltage of the floating diffusion FD is output from the selection transistor 109. That is, the pixel signal is read from each of the pixels 100 in the k-th row.

The count signal CNT(k) then goes low, and the first reset signal RST(k) temporarily goes high, resetting the floating diffusion FD to the first reset voltage VRST1 in each of the pixels 100 in the k-th row.

The ranging selection signal SEL_TOF then goes low, and the ranging address circuit 12 makes the first drive signal TOF(k) low, resuming the initial state.

The above operation is performed for the pixels 100 in the (k+1)th to (k+α)th rows row by row.

Next, the operation of the second pixels will be described.

In the light emission period, the camera address circuit 13 makes the second drive signal BRT(m) high. Also, the camera selection signal SEL_BRT and the first reset signal RST(m) go high. This turns on the reset transistor 105 and the selection transistor 109 in each of the pixels 100 in the m-th row. At this time, since the second power supply line 302 and the third power supply line 303 are connected through the switch 322, the second reset voltage VRST2 is supplied to the floating diffusion FD. That is, the floating diffusion FD in each of the pixels in the m-th row is reset to the second reset voltage VRST2.

The first reset signal RST(m) then goes low, and the exposure signal TRN(m) goes high. Therefore, exposure is performed in the pixels 100 in the m-th row. At this time, since the selection transistor 109 is on, a pixel signal is read from each pixel 100. The camera selection signal SEL_BRT, the exposure signal TRN(m), the second drive signal BRT(m), and the selection signal SEL(m) then go low, resuming the initial state.

Thereafter, the camera address circuit 13 makes the second drive signal BRT(1) high. Also, the camera selection signal SEL_BRT, the selection signal SEL(1), and the first reset signal RST(1) go high. This turns on the reset transistor 105 and the selection transistor 109 in each of the pixels 100 in the l-th row. At this time, since the second power supply line 302 and the third power supply line 303 are connected through the switch 322, the second reset voltage VRST2 is supplied to the floating diffusion FD. That is, the floating diffusion FD in each of the pixels in the 1-th row is reset to the second reset voltage VRST2.

The first reset signal RST(1) then goes low, and the exposure signal TRN(1) goes high. This turns on the overflow transistor 102 in each of the pixels 100 in the l-th row. At this time, since the second power supply line 302 and the third power supply line 303 are connected through the switch 322, the second reset voltage VRST2 is supplied to the avalanche photodiode 101. That is, the avalanche photodiode 101 in each of the pixels in the l-th row is reset to the second reset voltage VRST2.

The second drive signal BRT(1), the camera selection signal SEL_BRT, the exposure signal TRN(1), and the selection signal SEL(1) then go low, resuming the initial state.

The above operations are performed for the pixels 100 in the (m+1)th to (m+α)th rows and the (l+1)th to (l+α)th rows row by row.

With the above configuration, in the light-source scan period γ, in each of the pixels 100 in the k-th to (k+α)th rows selected as the first pixels, the avalanche photodiode 101 and the floating diffusion FD are reset to the first reset voltage VRST1. Also, in the light-source scan period γ, in each of the pixels 100 in the m-th to (m+α)th and l-th to (l+α)th rows selected as the second pixels, the avalanche photodiode 101 and the floating diffusion FD are reset to the second reset voltage VRST2 that is lower than the first reset voltage VRST1. Therefore, since the multiplication factor of the signal charges of the avalanche photodiode 101 in each of the second pixels can be reduced, the second pixels are allowed to perform operations suitable for camera image generation.

(Configuration of Address Circuit)

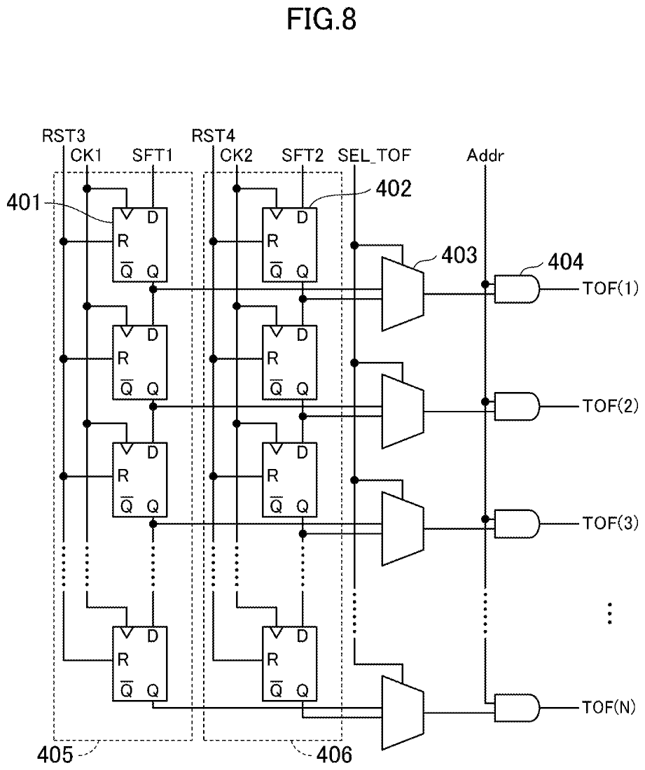

FIG. 8 is a circuit diagram showing a configuration example of the ranging address circuit in the solid-state imaging devices according to the first to third embodiments. As shown in FIG. 8, the ranging address circuit 12 includes an exposure address sub-circuit 405 including N D-flipflops 401, a readout address sub-circuit 406 including N D-flipflops 402, N selection circuits 403, and N AND gates 404. One each of the D-flipflops 401, the D-flipflops 402, the selection circuits 403, and the AND gates 404 are provided for each row of pixels 100.

Each of the D-flipflops 401 receives a first clock signal CK1 at its clock terminal and a third reset signal RST3 at its reset terminal. Also, the D-flipflops 401 are connected in series: for example, the D-flipflop 401 corresponding to the first row of pixels 100 receives a first shift signal SFT1 at its D terminal and is connected at its Q terminal to the D terminal of the D-flipflop 401 corresponding to the second row of pixels 100 and to the first input terminal of the selection circuit 403 corresponding to the first row of pixels 100. That is, a D-flipflop 401 is connected at its Q terminal to the D terminal of its subsequent D-flipflop 401 and to the first input terminal of the corresponding selection circuit 403.

Each of the D-flipflops 402 receives a second clock signal CK2 at its clock terminal and a fourth reset signal RST4 at its reset terminal. Also, the D-flipflops are connected in series: for example, the D-flipflop 402 corresponding to the first row of pixels 100 receives a second shift signal SFT2 at its D terminal and is connected at its Q terminal to the D terminal of the D-flipflop 402 corresponding to the second row of pixels 100 and to the second input terminal of the selection circuit 403 corresponding to the first row of pixels 100. That is, a D-flipflop 402 is connected at its Q terminal to the D terminal of its subsequent D-flipflop 402 and to the second input terminal of the corresponding selection circuit 403.

The selection circuit 403 outputs the signal input into the first input terminal or the signal input into the second input terminal to the corresponding AND gate 404 in accordance with an input control signal. Specifically, the selection circuit 403 receives the inverted form of the ranging selection signal SEL_TOF as the control signal. For example, when the ranging selection signal SEL_TOF is low, the selection circuit 403 outputs the signal input into the first input terminal, i.e., the signal output from the Q terminal of the D-flipflop 401, to the AND gate 404. On the contrary, when the ranging selection signal SEL_TOF is high, the selection circuit 403 outputs the signal input into the second input terminal, i.e., the signal output from the Q terminal of the D-flipflop 402, to the AND gate 404.

The AND gate 404 calculates the logical AND of the signal output from the selection circuit 403 and an address enable signal Addr, and outputs the first drive signal TOF(1) to TOF(N).

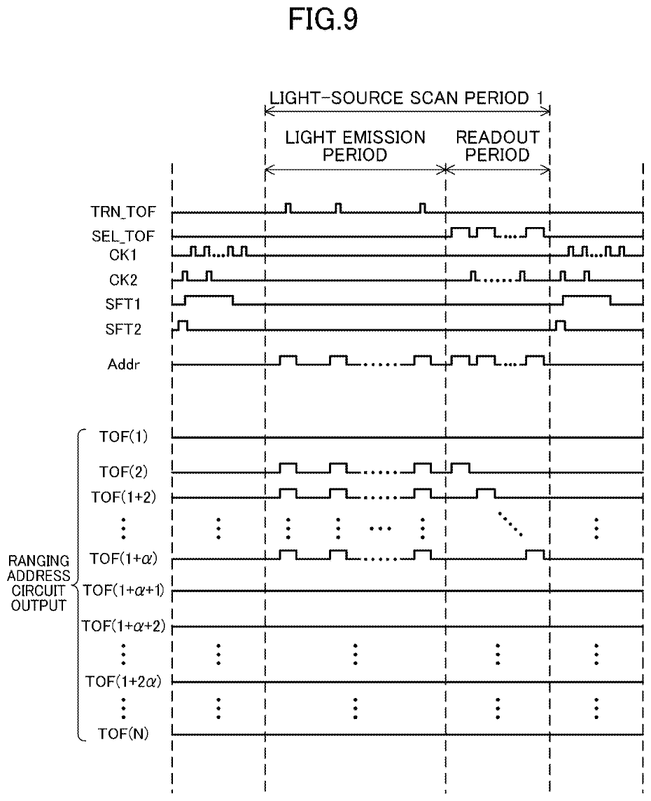

FIG. 9 shows an operation sequence of the ranging address circuit. Specifically, FIG. 9 shows the operation of the solid-state imaging device 1 in the light-source scan period 1. In FIG. 9, the ranging address circuit 12 selects pixels 100 in the 2nd to (l+α)th rows as the first pixels.

Prior to the light-source scan period 1, the first shift signal SFT1 is made high, and the first clock signal CK1 is made high α times. Thereafter, the first shift signal SFT1 is made low, and the first clock signal CK1 is made high once. With this, the signals output from the Q terminals of the D-flipflops 401 corresponding to the pixels 100 in the 2nd to (l+α)th rows become high.

Also, the second shift signal SFT2 is made high, and the second clock signal CK2 is made high once. Thereafter, the second shift signal SFT2 is made low, and the second clock signal CK2 is made high once. With this, the signal output from the Q terminal of the D-flipflop 402 corresponding to the pixels 100 in the 2nd row becomes high.

In the light emission period of the light-source scan period 1, the address enable signal Addr goes high. At this time, since the ranging selection signal SEL_TOF is low, the selection circuit 403 outputs the signal input into the first input terminal, i.e., the signal output from the Q terminal of the D-flipflop 401 to the AND gate 404. Therefore, the first drive signals TOF(2) to TOF(+α) become high.

Thereafter, the first drive signals TOF(2) to TOF(l+α) become high every time the address enable signal Addr goes high.

In the readout period of the light-source scan period 1, the ranging selection signal SEL_TOF and the address enable signal Addr go high. With this, the selection circuit 403 outputs the signal input into the second input terminal, i.e., the high-level signal output from the Q terminal of the D-flipflop 402 to the AND gate 404. Therefore, the first drive signal TOF(2) becomes high.

Thereafter, the ranging selection signal SEL_TOF and the address enable signal Addr go low, and the second clock signal CK2 goes high. That is, the signal output from the Q terminal of the D-flipflop 402 corresponding to the pixels 100 in the 2nd row becomes low, and the signal output from the Q terminal of the D-flipflop 402 corresponding to the pixels 100 in the 3rd row becomes high.

The ranging selection signal SEL_TOF and the address enable signal Addr then go high, and the second clock signal CK2 goes low. At this time, the first drive signal TOF(3) becomes high.

Thereafter, by performing a similar operation, the first drive signals TOF(4) to TOF(l+α) can be made high sequentially row by row.

With the above configuration, the ranging address circuit 12 can generate the first drive signals TOF(1) to TOF(N). In this embodiment, the camera address circuit 13 may be configured similarly to the ranging address circuit 12.

Other circuit configurations may be used to implement the ranging address circuit 12.

### Other Embodiments

While the above embodiments have been described as illustrations of the technology disclosed herein, the disclosed technology is not limited to these embodiments, but also applicable to their alterations in which changes, replacements, additions, and omissions have been appropriately made. Also, various components described in the above embodiments may be combined to prepare a new embodiment.

In the above embodiments, the multiplexer 14 may make the second reset signal OVF high before the exposure of pixels 100, to turn on the overflow transistor 102 thereby resetting the signal charges in the avalanche photodiode 101 in each pixel.

In the above embodiments, the multiplexer 14 may further include AND gates and OR gates so that the second reset signals OVF and the count signals CNT be generated in a manner similar to the generation of the exposure signals TRN, the selection signals SEL, and the first reset signals RST.

In the above embodiments, when the operation of one frame is divided into M light-source scan periods, the number of rows of the pixel array 11 is N, and the rows of pixels 100 selected as the first and second pixels are shifted by α rows every light-source scan period, α may be set at N/M. Otherwise, α may be set at less than N/M. In this case, in the one-frame operation, since the exposure and the readout of pixel signals are performed a plurality of times for the same second pixels, sharp camera images can be generated even when the intensity of the emission end of the light source 4 is weak.

In the above embodiments, while α rows of pixels 100 are selected as the first pixels, and 2α rows of pixels 100 are selected as the second pixels during the light-source scan period, the configuration is not limited to this. For example, more than α rows or less than α rows of pixels 100 may be selected as the first pixels, and more than 2α rows or less than 2α rows of pixels 100 may be selected as the second pixels.

The rows of pixels 100 selected as the first and second pixels every light-source scan period may be shifted by more than α rows or less than α rows.

In the above embodiments, each pixel 100 may include a photoelectric conversion element such as a photodiode in place of the avalanche photodiode 101.

According to the present disclosure, a solid-state imaging device usable for distance measurement and camera image generation is provided. The present disclosure is therefore applicable to range cameras, for example.

What is claimed is:

1. A solid-state imaging device, comprising:
a plurality of pixels arranged in a matrix;
a ranging address circuit that selects pixels included in given number of rows, among the plurality of pixels, as first pixels used for distance measurement in a scan period during which exposure of the plurality of pixels and readout of pixel signals from the plurality of pixels are performed;
a camera address circuit that selects pixels other than the first pixels, among the plurality of pixels, as second pixels used for camera image generation in the scan period;
a first drive circuit that drives the first pixels; and
a second drive circuit that drive the second pixels, wherein
the first drive circuit performs simultaneous exposure of the first pixels in a light emission period included in the scan period, and also performs readout of pixel signals from the first pixels in a readout period after the light emission period, and
the second drive circuit performs readout of pixel signals from the second pixels in a period including the light emission period in the scan period.

2. The solid-state imaging device of claim 1, wherein
the ranging address circuit changes the rows selected as the first pixels, among the plurality of pixels, every scan period.

3. The solid-state imaging device of claim 1, wherein
the ranging address circuit outputs a first drive signal indicating a row of pixels to be exposed among the first pixels, and
the first drive circuit receives the first drive signal from the ranging address circuit, also receives a ranging exposure signal indicating the timing of exposing the first pixels, calculates logical AND of the first drive signal and the ranging exposure signal, and outputs the result to the first pixels.

4. The solid-state imaging device of claim 1, wherein
the pixels each include an avalanche photodiode, and
a charge storage region of each of the second pixels is reset by a second reset voltage different from a first reset voltage for resetting a charge storage region of each of the first pixels.

5. The solid-state imaging device of claim 1, wherein
the second drive circuit performs exposure of the second pixels and readout of pixel signals from the second pixels for each row of the second pixels in the period including the light emission period in the scan period.

6. The solid-state imaging device of claim 1, wherein
the second drive circuit performs simultaneous exposure of the second pixels, and performs readout of pixel signals from the second pixels for each row of the second pixels, in the period including the light emission period in the scan period.

7. An imaging device comprising:
the solid-state imaging device of claim 1; and
a light source capable of emitting linear projection light extending in a row direction, wherein
the ranging address circuit selects pixels corresponding to an emission position of the projection light as the first pixels.

8. The imaging device of claim 7, wherein
the light source moves the projection light in a column direction every scan period, and
the ranging address circuit changes the pixels selected as the first pixels every scan period.
